(19) United States
(12) Patent Application Publication
(10) Pub. No.: US 2026/0324890 A1
(43) Pub. Date: Oct. 22, 2026

(54) PUMP ASSEMBLY HAVING OFFSET DISCHARGE TUBE

(71) Applicant: Server Products, Inc., Richfield, WI (US)

(72) Inventor: Gerald A. RUSCH, Fond du Lac, WI (US)

(21) Appl. No.: 19/104,609

(22) PCT Filed: Aug. 29, 2023
(86) PCT No.: PCT/US2023/073054

§ 371 Date: Feb. 18, 2025

Related U.S. Application Data
(60) Provisional application No. 63/403,525, filed on Sep. 2, 2022.

(51) Int. Cl. A47G 19/18

(52) U.S. Cl. CPC A47G 19/183

(57) ABSTRACT

The present disclosure relates to a food pump that includes a manual pump extending into a container of flowable food product and a discharge tube that extends from the container to dispense the food product from a dispensing end. The dispensing end of the discharge tube is offset from a pumping axis of the pump. The discharge tube includes one or more bends such that the dispensing end of the discharge tube is laterally offset from the pumping axis of the pump. Such offset enhances the access to the pump during operation by an operator.

### CROSS-REFERENCES TO RELATED APPLICATIONS

This application claims the benefit of U.S. Provisional Patent Application No. 63/403,525, filed Sep. 2, 2022, which is incorporated herein by reference.

### FIELD

The present disclosure generally relates to a discharge tube for a food product dispenser. More specifically, the present disclosure relates to a discharge tube that is offset from a pumping axis of a manual pump of a food product dispenser.

### BACKGROUND

Food product dispensers are used in restaurants, fast food establishments, convenience stores, grocery stores, and the like to dispense liquid food products, such as but not limited to syrups, fudges and sauces for ice cream, condiments, sandwich toppings, dairy products and other food products. Many food product dispensers include a container that holds the food product and a manually operated piston pump that can be actuated by an operator to dispense the food product out of a discharge tube into a cup, container, bowl, or onto food or a plate. Typically, the discharge tube is aligned with the actuator of the piston pump such that the operator must actuate the pump from the side while holding a container or food item beneath the dispensing end of the discharge tube. In addition, presently available food product dispensers often include a discharge tube that has a horizontal portion that leads to the dispensing end. Such configuration can cause the food product to drip after the desired amount of food product has been dispensed during the pumping stroke.

Therefore, a need exists for an improved food product dispenser that provides better access to the manual pump during the pumping operation and that reduces leakage of the food product from the discharge tube.

### SUMMARY

The present disclosure relates to a food pump that includes a manual pump extending into a container of flowable food product and a discharge tube that extends from the container to dispense the food product from a dispensing end. The discharge tube includes one or more bends such that the dispensing end of the discharge tube is laterally offset from the pumping axis of the pump. Such offset enhances the access to the pump during operation by an operator.

In a first aspect, a food product dispenser includes a container configured to hold a flowable food product; a manual pump extending into the container, having a pumping axis extending through the manual pump in a vertical direction, and configured to pump the flowable food product from the container; and a discharge tube coupled to the manual pump, extending from the container, and having a dispensing end configured to dispense the flowable food product, wherein the dispensing end of the discharge tube is laterally offset from the pumping axis of the manual pump.

In some cases, the dispensing end is laterally offset from the pumping axis by about 1.75 inches to about 2.5 inches. In various instances, the discharge tube comprises at least one bend to laterally offset the dispensing end from the pumping axis of the manual pump. The at least one bend in the discharge tube can be between about 50 and about 70 degrees. In some cases, the at least one bend in the discharge tube can be about 60 degrees.

In various embodiments, the discharge tube comprises a first bend and a second bend to laterally offset the dispensing end from the pumping axis of the manual pump. In some cases, a first angle of the first bend is about the same as a second angle of the second bend. The first angle of the first bend can be about 60 degrees. In other cases, a first angle of the first bend is different from a second angle of the second bend.

In some instances, the discharge tube includes a vertically extending lower portion extending from a lid of the container; a first bend coupled to the vertically extending lower portion; a transition portion coupled to the first bend; a second bend coupled to the transition portion; and a vertically extending upper portion coupled to the second bend. In some cases, the discharge tube further includes a third bend coupled to the vertically extending upper portion; an extension portion coupled to the third bend; a fourth bend coupled to the extension portion; and a downward portion coupled to the fourth bend and having the dispensing end of the discharge tube. In some embodiments, the extension portion is angled upward relative to a horizontal axis extending through the discharge tube.

In some embodiments, the discharge tube comprises a vertically extending lower portion extending from a lid of the container; a first bend directly coupled to the vertically extending lower portion and extending laterally relative to the pumping axis; a transition portion directly coupled to the first bend and extending upward and laterally relative to the pumping axis; a second bend directly coupled to the transition portion and extending upward relative to the pumping axis; and a vertically extending upper portion directly coupled to the second bend. The discharge tube can further include a third bend directly coupled to the vertically extending upper portion; an extension portion directly coupled to the third bend; a fourth bend directly coupled to the extension portion; and a downward portion directly coupled to the fourth bend and having the dispensing end of the discharge tube.

In another aspect, a food product dispenser can include a pump extending into a flowable food product, having a pumping axis extending through the pump, and configured to pump the flowable food product; and a discharge tube coupled to the pump and having a dispensing end configured to dispense the flowable food product, wherein the dispensing end of the discharge tube is offset from the pumping axis of the pump.

In some cases, the discharge tube comprises at least one bend to laterally offset the dispensing end from the pumping axis of the pump. The at least one bend in the discharge tube can be about 60 degrees.

In various embodiments, the discharge tube comprises a first bend and a second bend to laterally offset the dispensing end from the pumping axis of the pump. A first angle of the first bend can be about the same as a second angle of the second bend.

In yet another aspect, a method of forming a food product dispenser might include providing a pump configured to pump a flowable food product, wherein the pump comprises a pumping axis extending through the pump; providing a discharge tube having a dispensing end configured to dispense the flowable food product, wherein the dispensing end of the discharge tube is configured to be offset from the pumping axis of the pump; and coupling the discharge tube to the pump.

Various other features, objects and advantages of the invention will be made apparent from the following description taken together with the drawings.

### BRIEF DESCRIPTION OF THE DRAWINGS

The present disclosure will be better understood and features, aspects and advantages other than those set forth above will become apparent when consideration is given to the following detailed description thereof. Such detailed description makes reference to the following drawings.

FIG. 1 is a side view of the food product dispenser mounted to counter surface;

FIG. 2 is a is a perspective view of a portion of the food product dispenser of FIG. 1;

FIG. 3 is a perspective view of the pump and the discharge tube of the food product dispenser of FIG. 1;

FIG. 4 is a side view of the pump of the food product dispenser of FIG. 1;

FIG. 5 is a section view of the pump of the food product dispenser of FIG. 1;

FIG. 6A is a perspective view of the discharge tube of the food product dispenser of FIG. 1 with a collar;

FIG. 6B is a perspective view of the discharge tube of the food product dispenser of FIG. 1 with the collar removed;

FIG. 7 is a perspective view of the pump and the discharge tube of the food product dispenser of FIG. 1;

FIG. 8 is a top view of the pump and the discharge tube of the food product dispenser of FIG. 1; and

FIG. 9 is a side view of the pump and the discharge tube of the food product dispenser of FIG. 1.

### DETAILED DESCRIPTION

Before any embodiments of the present disclosure are explained in detail, it is to be understood that the present disclosure is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” “attached,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations. Additionally, unless otherwise specified or limited, the terms “about” and “approximately,” as used herein with respect to a reference value or ratio, refer to variations from the reference value or ratio of ±20% or less (e.g., ±15, ±10%, ±5%, etc.), inclusive of the endpoints of the range.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Some of the discussion below describes a food product dispenser comprising a discharge tube and manual pump. The context and particulars of this discussion are presented as examples only. For example, embodiments of the disclosed invention can be configured in various ways, including with other shapes and arrangements of elements that are expressly described or illustrated. Similarly, embodiments of the invention can be used with arrangements of food dispensers, or other assemblies other than those expressly illustrated or described herein.

Food product dispensers having manual pumps are used in restaurants, fast food establishments, convenience stores, and the like to dispense liquid food products. Typically, in these manually operated food product dispensers, the discharge tube is aligned with the actuator of the pump such that the operator must reach around the discharge tube to operate the manual pump from the side while holding a container or food item beneath the dispensing end of the discharge tube. In addition, presently available food dispensers often include a discharge tube head that leaks after the pump has been manually operated.

Embodiments of the present disclosure can address these and other issues. For example, in some embodiments, a food product dispenser is provided with a discharge tube end that is offset from the manual pump. In a non-limiting example, the discharge tube can have one or more bends or curves so that the discharge tube end is offset from the manual pump. Additionally, an extension portion coupled to the dispensing end of the discharge tube can be angled upward relative to a horizontal axis thereby reducing or preventing leaks from the dispensing end of the discharge tube.

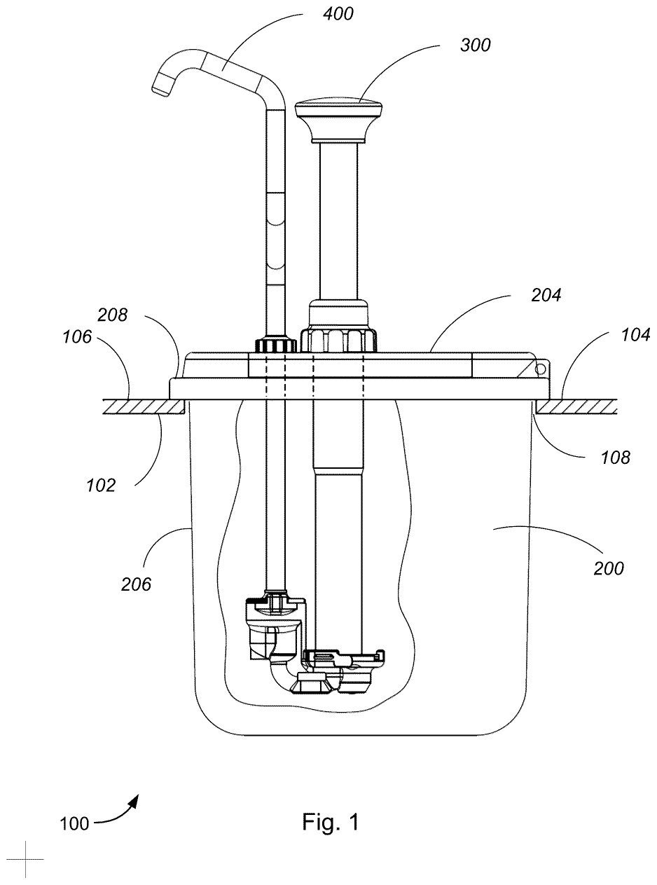

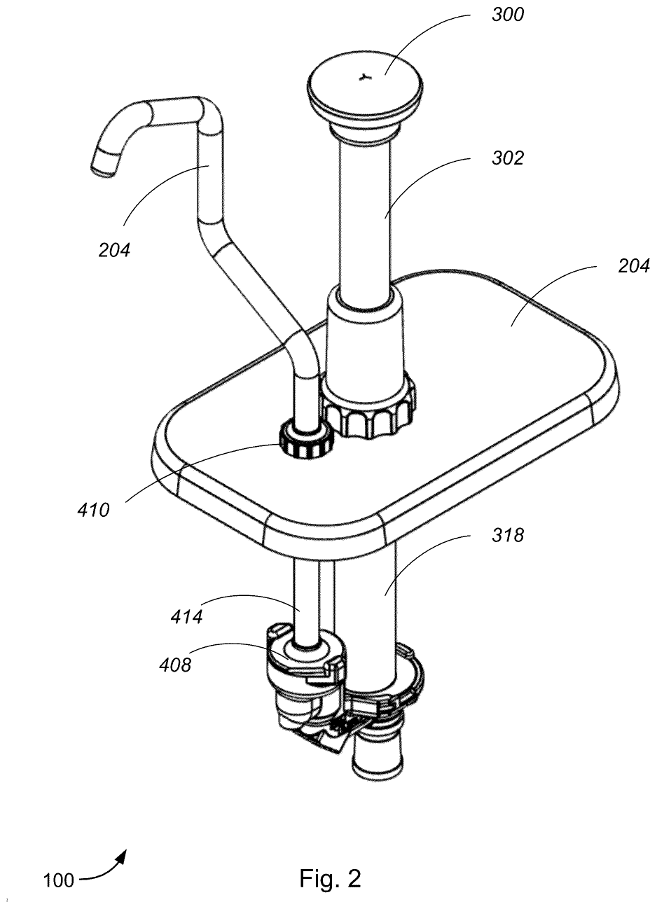

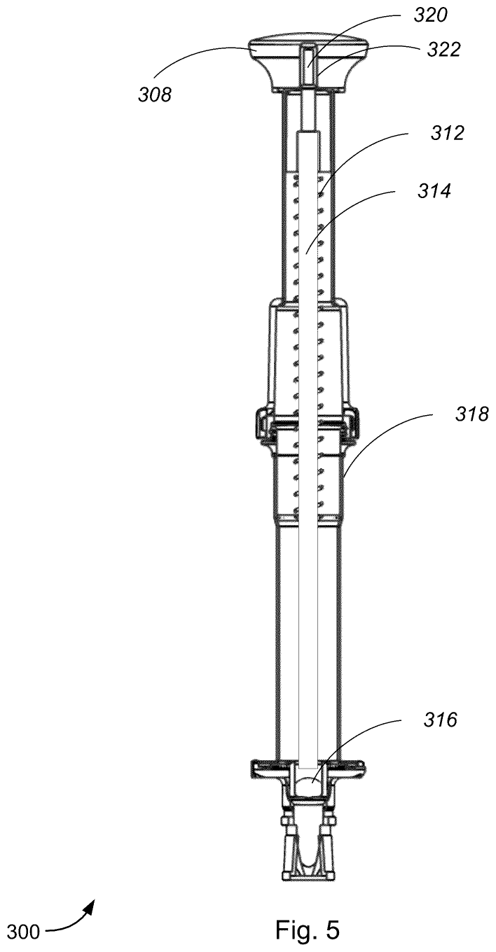

FIGS. 1-9 illustrate an improved food product dispenser 100 for dispensing controlled portions of a liquid food product, such as but not limited to condiments, sauces, syrups, ice cream toppings, sandwich toppings or any other type of flowable food product that can either be added to another food item or consumed separately from or with another food item.

FIG. 1 illustrates a food product dispenser 100 of the present disclosure. In the embodiment shown in FIG. 1, the food product dispenser 100 includes a food product container 200, a manual pump 300, and a discharge tube 400. In some cases, the food product dispenser 100 is mounted such that the food container 200 is suspended substantially below a lower counter surface 102 of a counter 104 and the manual pump 300 and the discharge tube 400 extend through the counter 104 to an upper counter surface 106 of the counter 104. In some cases, the food container 200 can be mounted to the lower counter surface 102 of counter 104. In other cases, a lid 202 of the container 200 can be positioned above the counter 104 and be mounted to the upper counter surface 106. In other contemplated embodiments, a bottom surface of the food container 200 could be configured to be supported by or rest upon the upper counter surface 106 rather than suspended below the lower counter surface 102.

In some cases, the container 200 could be configured to hold a flowable food product. In other cases, the container could a self-sealing food package, such as a flexible bag or pouch. Alternatively, the container 200 could be a bottle or other type of container capable of holding a flowable food product. In some cases, the container 200 might be configured to hold the self-sealing food package, bottle, or other type of container capable of holding or supporting a flowable food product, or the like. In some cases, the container 200 can be sized to hold the self-sealing food package, bottle, or other type of container capable of holding a flowable food product.

In some cases, a flowable food product or self-sealing food package, bottle, or other type of container capable of holding or supporting a flowable food product can be inserted into the container 200 via the lid 202. Alternatively, in other cases, the flowable food product, self-sealing food package, bottle, or other type of container capable of holding or supporting a flowable food product can be inserted into the container 200 via a side 206 of the container 200. In some cases, the lid 202 includes a lip 208 sized to mount to or engage with an upper surface 106 of the counter 104. In some cases, the lip 208 is configured to extend around an opening 108 of the counter 104. The opening 108 of the counter 104 can be sized to allow the container 200 to pass through the opening 108.

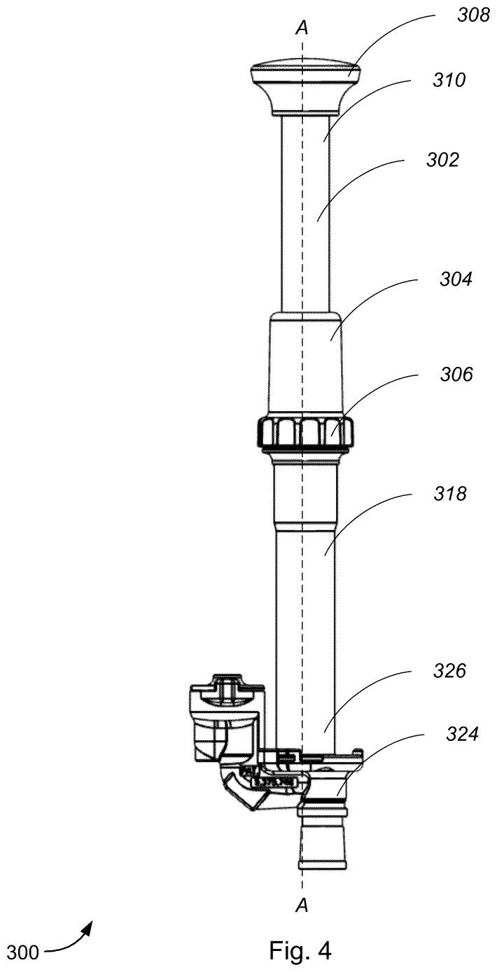

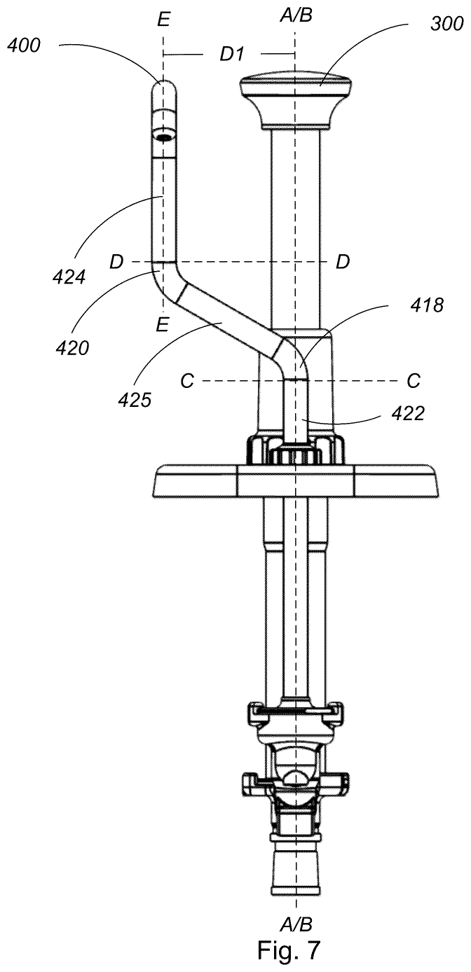

The food product dispenser 100 includes a pump 300. The pump 300 can be a manual pump (e.g., a hand operated piston-type displacement pump). The pump 300 includes a head tube 302 that extends above the top surface 204 of the lid 202 of the container 200. In various embodiments, the head tube 302 of the pump 300 extends along a pumping axis A-A that is about or substantially vertical as shown in FIGS. 4 and 7. The head tube 302 includes an outwardly extending flange 303 having a collar 306 that can be tightened to limit the movement of the pump 300 relative to the lid 202 of the container 200. In some cases, the collar 306 can be threaded or screwed onto a corresponding threaded portion of the lid 202. The head tube 302 further includes a knob 308 coupled to an upper end 310 of the head tube 302. The knob 308 is designed for engagement by the hand of an operator.

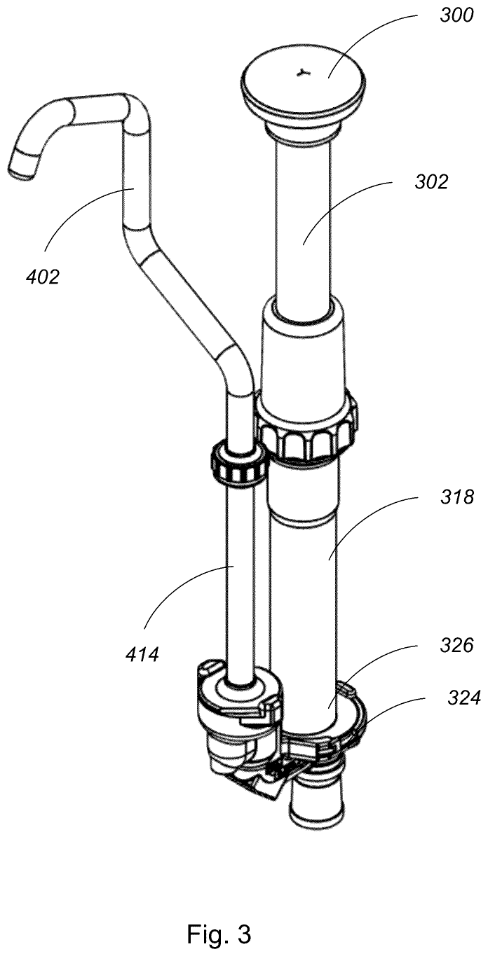

The pump 300 additionally includes a spring 312 and a piston rod 314 having a piston 316 shown in FIG. 3. The spring 312 and piston rod 314 having the piston 316 are contained within the head tube 302 and extend into a lower tube 318 located below counter 104. An interior of the head tube 302 is in communication an interior of the lower tube 318. The spring 312 biases against the piston rod 314 and pushes the piston rod 314 upward into an initial position. A first end 320 of the piston rod 314 is attached to an inner surface 322 of the knob 308. Further details of the configuration of the piston and piston rod are shown in U.S. Pat. No. 5,375,746, the disclosure of which is incorporated by reference in its entirety.

In operation (e.g., during the pumping action by an operator), the operator exerts a downward force on the knob 308 of the food product dispenser 100, which causes the knob 308 and head tube 302 to move downward and the piston rod 314 and piston 316 to move against the bias force generated by the spring 312. The movement of the piston 316 in the downward direction along the pumping axis A-A creates a flow of the food product through a valve body 324 that is connected to a lower end 326 of the lower tube 318. The valve body 324 includes a valve that controls the flow direction of the flowable food product during operation of the food product dispenser 100. Additionally, during the downward movement of the head tube 302 and the piston 316, the flowable food product is pumped out of the valve body 324 and into the discharge tube 400. When the operator removes pressure from the knob 308, the internal bias spring returns the head tube 302, knob 308, the piston rod 314, and piston 316 to the initial position of FIG. 1, thereby drawing additional flowable food product from the container 200 into the pump 300 through the valve body 324. This process is repeated each time food product is dispensed.

The food product dispenser 100 further includes discharge tube 400. An upper portion 402 of the discharge tube 400 extends above the top surface 204 of the lid 202 of the container 200. The discharge tube 400 is a continuous tube that extends from an inlet end 404 to a discharge or dispensing end 406. In the embodiment illustrated, the discharge tube 400 is formed from a metal material, such as stainless steel or aluminum, which can be easily cleaned when needed. In some cases, the discharge tube 400 can be formed from plastic or other material capable of dispensing a flowable food product.

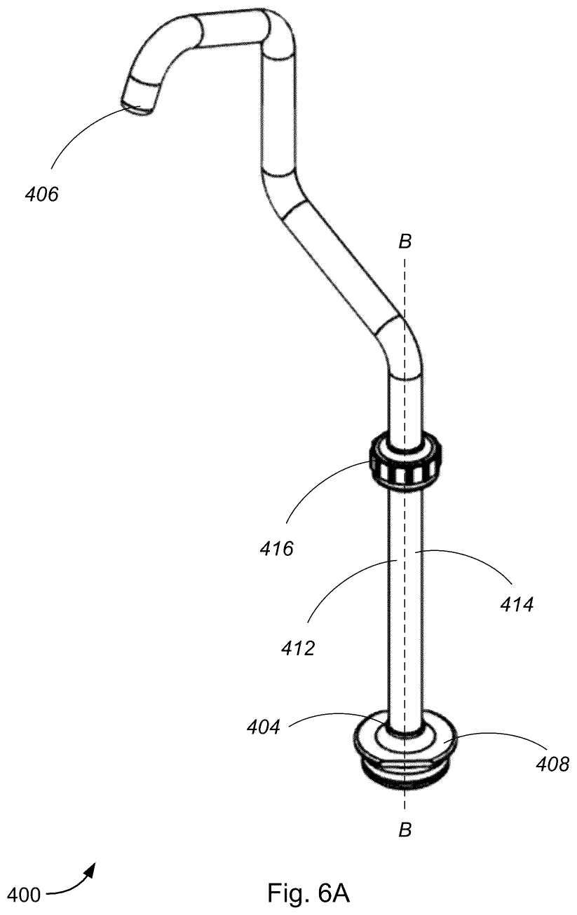

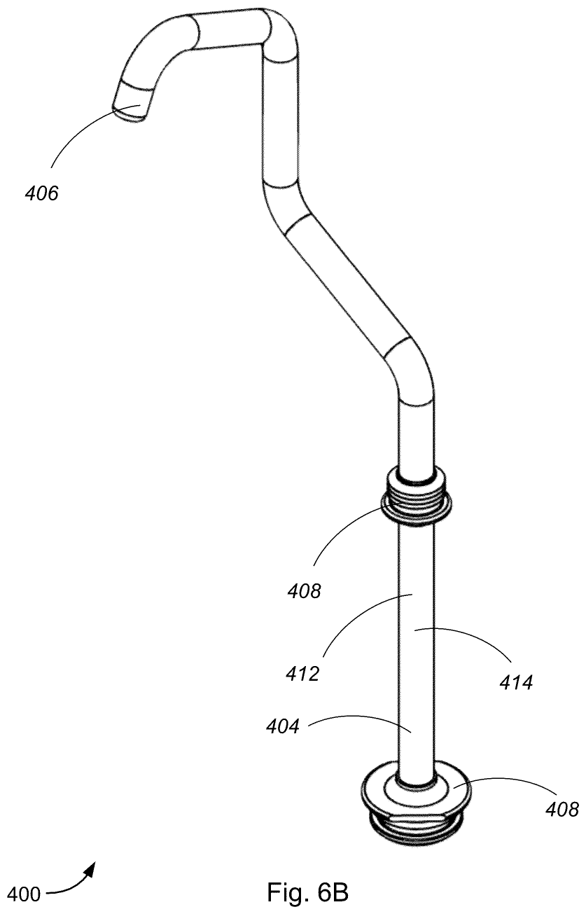

The discharge tube 400 includes a lower bushing 408 that is received by the valve body 324 of the pump 300 to provide a fluid connection between the discharge tube 400 and the pump 300. A threaded ferrule 410, as shown in FIG. 6B, is attached to an outer surface 412 on a lower portion 414 of the discharge tube 400. The lower portion 414 is the portion of the discharge tube 400 that is located within the container 200 and generally extends along a vertical lower portion discharge tube axis B-B. In some cases, the pumping axis A-A is parallel to the vertical lower portion discharge tube axis B-B. As shown in FIG. 6A, a collar 416 is received on the threaded ferrule 410 to hold the discharge tube 400 in place relative to the lid 202 of the container 200.

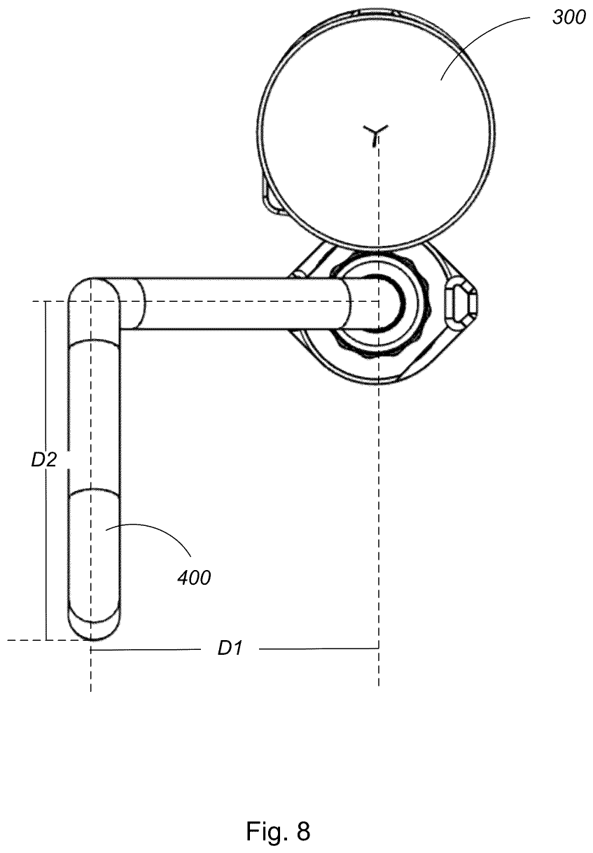

Referring to FIGS. 7 and 8, the discharge tube 400 of the present disclosure is designed to create an offset of the dispensing end 406 relative to the lower portion vertical discharge tube axis B-B or relative to the vertical pump head axis A-A. This offset is created by a first bend 418 and a second bend 420 that are formed in the length of the upper portion 402 of the discharge tube 400.

In some cases, the upper portion 402 of the discharge tube 400 further has vertically extending lower portion 422 extending about vertically from the lid 202 of the container 200 and a vertically extending upper portion 424 extending about vertically from the second bend 420. As shown in FIG. 7, the vertically extending lower portion 422 extends above the top surface 204 of the lid 202 of the container 200. The vertically extending lower portion 422 is coupled (sometimes directly coupled) to the first bend 418. The first bend 418 can be a lateral bend that creates an upward and outwardly (e.g., laterally) extending transition portion 425 that extends between the first bend 418 and the second bend 420. In some cases, the extending transition portion 425 is coupled (sometimes directly coupled) to the first bend 418 and the second bend 420. In the illustrated embodiment, the first bend 418 is between about 50 and 70 degrees and is preferably about 60 degrees from a horizontal axis C-C which is about perpendicular to axis A-A and/or axis B-B, although other angles are contemplated.

The second bend 420 is designed to create the vertically extending upper portion 424. In order to create the vertically extending upper portion 424, the second bend 420 is an upward bend and can be a same angle as the first bend 418. However, the angle for the second bend 420 could be different from the first bend 418 as long as the second bend 420 transitions into the vertically extending upper portion 424 (which in some cases may not be vertical). In some cases, the second bend 420 is between about 50 and 70 degrees and is preferably about 60 degrees from a horizontal axis D-D which is about perpendicular to vertical axis B-B, although other angles are contemplated. The vertically extending upper portion 424 is centered along a dispensing axis E-E that is vertical and is laterally spaced from the pumping axis A-A by a distance D1, which is shown in FIGS. 7 and 8.

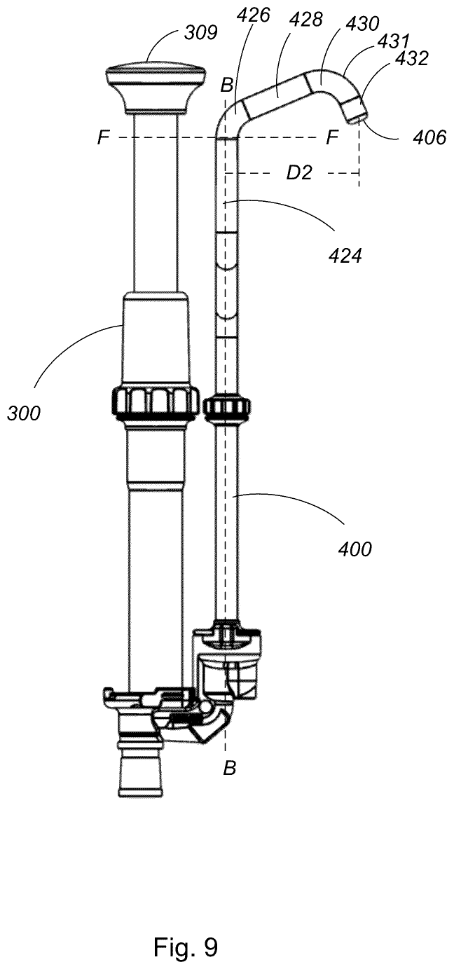

Shown in FIG. 9, the vertically extending upper portion 424 can extend to a third bend 426. The third bend 426 is between about 50 and 70 degrees and is preferably about 60 degrees from a horizontal axis F-F which is about perpendicular to vertical axis B-B. Third bend 426 forms the transition between the vertically extending upper portion 424 and an extension portion 428. In some cases, the extension portion 428 can extend upward at an angle relative to horizontal axis F-F. By extending the extension portion 428 upward instead of horizonal, leakage of a flowable food product from the dispensing end 406 can be reduced or prevented.

The extension portion 428 can terminate in a fourth bend 430 that creates a downward portion 432 that terminates at the dispensing end 406. In some cases, a top surface 431 of the fourth bend 430 can be substantially level with a top surface 309 of the knob 308 as shown in FIG. 9. Alternatively, in other cases a top surface 431 of the fourth bend 430 can extend past a top surface 309 of the knob 308 as shown in FIG. 1. The fourth bend 430 is between about 50 and 70 degrees and is preferably about 60 degrees. The combination of the extension portion 428, the fourth bend 430, and the downward portion 432 position the dispensing end 406 a distance D2 from the discharge tube axis B-B, as shown in FIGS. 8 and 9.

As can be best seen in FIGS. 7-8, the configuration of the discharge tube 400, and specifically the configuration of the multiple bends in the discharge tube 400, laterally spaces the dispensing end 406 from the pumping axis A-A and the discharge tube axis B-B by the distance D1 and positions the dispensing end 406 forward of the discharge tube axis D-D by the distance D2. In one contemplated embodiment, the distance D1 could be in the range of 1 ¾-2 ½ inches, and preferably 2 1/16 inches, although other distances are contemplated as being within the scope of the present disclosure and the specific distance is disclosed for informational purposes only. In the embodiment illustrated, the distance D2 is selected such that the dispensing end 406 comes to or extends slightly past the edge of the lid 202. However, other distances D1 could be selected depending on the installation location of the food pump of the present disclosure.

As illustrated in the front view of FIG. 7, the dispensing end 406 is offset from the pumping axis A-A by the distance D1. During use of the food product dispenser 100 to dispense the flowable food product, the operator can place a receptacle or food item beneath the dispensing end 406. Since the dispensing end 406 is offset from the pumping axis A-A, the operator will have more room to actuate the pump 300 by depressing the knob 308 using the hand of the operator. In past pumps, the dispensing end 406 is generally aligned with the pumping axis A-A, which restricts the access to the knob 308.

As can be seen in the side view of FIG. 9, since the third bend 426, the extension portion 428 and the fourth bend 430 are all generally upward in direction, the discharge tube 400 prevents or reduces dripping since the flowable food product will travel back into the discharge tube 400 due to gravity after the completion of the pumping stroke.

Thus, embodiments of the inventions provide improved discharge tube and pump for food dispensers. In some embodiments, the discharge tube according to the present disclosure is oriented such that an operator of the food dispenser has clear access to actuate a knob of the pump. Additionally, the discharge tube described provides for easier cleaning of the food product dispenser by reducing or preventing the discharge tube from leaking.

In some implementations, devices or systems disclosed herein can be utilized or installed using methods embodying aspects of the invention. Correspondingly, description herein of particular features or capabilities of a device or system is generally intended to inherently include disclosure of a method of using such features for intended purposes and of implementing such capabilities. Similarly, express discussion of any method of using a particular device or system, unless otherwise indicated or limited, is intended to inherently include disclosure, as embodiments of the invention, of the utilized features and implemented capabilities of such device or system.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A food product dispenser comprising:
a container configured to hold a flowable food product;
a manual pump extending into the container, having a pumping axis extending through the manual pump in a vertical direction, and configured to pump the flowable food product from the container; and
a discharge tube coupled to the manual pump, extending from the container, and having a dispensing end configured to dispense the flowable food product, wherein the dispensing end of the discharge tube is laterally offset from the pumping axis of the manual pump.

2. The food product dispenser of claim 1, wherein the dispensing end is laterally offset from the pumping axis by about 1.75 inches to about 2.5 inches.

3. The food product dispenser of claim 1, wherein the discharge tube comprises at least one bend to laterally offset the dispensing end from the pumping axis of the manual pump.

4. The food product dispenser of claim 3, wherein the at least one bend in the discharge tube is between about 50 and about 70 degrees.

5. The food product dispenser of claim 3, wherein the at least one bend in the discharge tube is about 60 degrees.

6. The food product dispenser of claim 1, wherein the discharge tube comprises a first bend and a second bend to laterally offset the dispensing end from the pumping axis of the manual pump.

7. The food product dispenser of claim 6, wherein a first angle of the first bend is about the same as a second angle of the second bend.

8. The food product dispenser of claim 7, wherein the first angle of the first bend is about 60 degrees.

9. The food product dispenser of claim 6, wherein a first angle of the first bend is different from a second angle of the second bend.

10. The food product dispenser of claim 1, wherein the discharge tube comprises:
a vertically extending lower portion extending from a lid of the container;
a first bend coupled to the vertically extending lower portion;
a transition portion coupled to the first bend;
a second bend coupled to the transition portion; and
a vertically extending upper portion coupled to the second bend.

11. The food product dispenser of claim 10, wherein the discharge tube further comprises:
a third bend coupled to the vertically extending upper portion;
an extension portion coupled to the third bend;
a fourth bend coupled to the extension portion; and
a downward portion coupled to the fourth bend and having the dispensing end of the discharge tube.

12. The food product dispenser of claim 11, wherein the extension portion is angled upward relative to a horizontal axis extending through the discharge tube.

13. The food product dispenser of claim 1, wherein the discharge tube comprises:
a vertically extending lower portion extending from a lid of the container;
a first bend directly coupled to the vertically extending lower portion and extending laterally relative to the pumping axis;
a transition portion directly coupled to the first bend and extending upward and laterally relative to the pumping axis;
a second bend directly coupled to the transition portion and extending upward relative to the pumping axis; and
a vertically extending upper portion directly coupled to the second bend.

14. The food product dispenser of claim 13, wherein the discharge tube further comprises:
a third bend directly coupled to the vertically extending upper portion;
an extension portion directly coupled to the third bend;
a fourth bend directly coupled to the extension portion; and
a downward portion directly coupled to the fourth bend and having the dispensing end of the discharge tube.

15. A food product dispenser comprising:
a pump extending into a flowable food product, having a pumping axis extending through the pump, and configured to pump the flowable food product; and
a discharge tube coupled to the pump and having a dispensing end configured to dispense the flowable food product, wherein the dispensing end of the discharge tube is offset from the pumping axis of the pump.

16. The food product dispenser of claim 15, wherein the discharge tube comprises at least one bend to laterally offset the dispensing end from the pumping axis of the pump.

17. The food product dispenser of claim 16, wherein the at least one bend in the discharge tube is about 60 degrees.

18. The food product dispenser of claim 15, wherein the discharge tube comprises a first bend and a second bend to laterally offset the dispensing end from the pumping axis of the pump.

19. The food product dispenser of claim 18, wherein a first angle of the first bend is about the same as a second angle of the second bend.

20. A method of forming a food product dispenser, the method comprising:
providing a pump configured to pump a flowable food product, wherein the pump comprises a pumping axis extending through the pump;
providing a discharge tube having a dispensing end configured to dispense the flowable food product, wherein the dispensing end of the discharge tube is configured to be offset from the pumping axis of the pump; and coupling the discharge tube to the pump.
